(19) United States
(12) Patent Application Publication
(10) Pub. No.: US 2026/0065873 A1
(43) Pub. Date: Mar. 5, 2026

(54) DISPLAY PANEL AND DRIVING METHOD THEREOF, AND DISPLAY APPARATUS

(71) Applicant: HKC CORPORATION LIMITED, Shenzhen (CN)

(72) Inventors: Yuanchen WANG, Shenzhen (CN); Xianyu WANG, Shenzhen (CN); Mengling WANG, Shenzhen (CN); Xu ZHANG, Shenzhen (CN); Min GUO, Shenzhen (CN); Pei XU, Shenzhen (CN)

(21) Appl. No.: 19/316,531

(22) Filed: Sep. 2, 2025

(30) Foreign Application Priority Data
Sep. 3, 2024 (CN) 202411224334.7

(51) Int. Cl. G09G 3/36; G09G 3/3266; G09G 3/3275

(52) U.S. Cl. CPC G09G 3/3688; G09G 3/3266; G09G 3/3275; G09G 3/3677; G09G 2320/0233; G09G 2360/148

(57) ABSTRACT

A display panel and a driving method thereof, and a display apparatus are provided. The display panel includes multiple pixel units. Each data line is electrically connected to a column of the multiple pixel units. A source driving module is electrically connected to multiple data lines and outputs data signals to the multiple data lines. Each scan line is electrically connected to a row of the multiple pixel units for inputting scan signals to the multiple pixel units. A gate driving module includes multiple gate driving units and multiple voltage division units. One gate driving unit is electrically connected to one voltage division unit and one scan line. The gate driving unit outputs a driving signal to the voltage division unit to form the scan signal. In a direction away from the source driving module, voltages of the scan signals in the multiple scan lines are sequentially increased.

### CROSS-REFERENCE TO RELATED APPLICATIONS

This application claims priority under 35 U.S. C. § 119(a) to Chinese Patent Application No. 202411224334.7, filed Sep. 3, 2024, the entire disclosure of which is incorporated herein by reference.

### TECHNICAL FIELD

The present disclosure relates to the field of display technology, and in particular, to a display panel and a driving method thereof, and a display apparatus.

### BACKGROUND

In a display panel of the related art, when data lines transmit data signals to pixel units for charging, capacitances are formed between the data lines and gate scan lines, and between the data lines and common electrodes. The capacitances, together with the inherent resistance of the data lines, leads to relatively large voltage drops at one end of each of the data lines away from a source driving module, which results in uneven charging of the pixel units at two ends of each of the data lines, causing uneven display luminance in the display panel.

### SUMMARY

In a first aspect, the disclosure provides a display panel. The display panel includes multiple pixel units, multiple data lines, a source driving module, multiple scan lines, and a gate driving module. The multiple pixel units are distributed in an array. Each of the multiple data lines is electrically connected to a column of the multiple pixel units. The source driving module is electrically connected to the multiple data lines, and the source driving module is configured to output data signals to the multiple data lines. Each of the multiple scan lines is electrically connected to a row of the multiple pixel units for inputting scan signals to the multiple pixel units. The gate driving module is electrically connected to the multiple scan lines, and the gate driving module is configured to output the scan signals to the multiple scan lines. In a direction away from the source driving module, voltages of the scan signals in the multiple scan lines are sequentially increased. The gate driving module includes multiple gate driving units and multiple voltage division units, where one of the multiple gate driving units is electrically connected to one of the multiple voltage division units and one of the multiple scan lines. The multiple gate driving units are configured to output driving signals to the multiple voltage division units, and the driving signals are converted into the scan signals through the multiple voltage division units.

In a second aspect, the disclosure provides a display panel driving method for driving the display panel. The display panel driving method includes the following. Voltages of scan signals in multiple scan lines are sequentially increased in a direction away from a source driving module.

In a third aspect, the disclosure provides a display apparatus, including a housing and the display panel. The housing is configured to accommodate the display panel.

### BRIEF DESCRIPTION OF THE DRAWINGS

In order to describe technical solutions of embodiments of the disclosure more clearly, the following will give a brief introduction to the accompanying drawings used for describing the embodiments. Apparently, the accompanying drawings hereinafter described are some embodiments of the present disclosure. Based on these drawings, those of ordinary skill in the art can also obtain other drawings without creative effort.

FIG. 1 is a schematic structural diagram of a circuit of a display panel provided in an embodiment of the disclosure.

FIG. 2 is a schematic structural diagram of a circuit of a gate driving module including a gate driving unit provided in an embodiment of the disclosure.

FIG. 3 is a schematic structural diagram of a circuit of a display panel including a detection module provided in an embodiment of the disclosure.

FIG. 4 is a schematic structural diagram of a circuit of a display panel in a misalignment charging mode provided in an embodiment of the disclosure.

FIG. 5 is a schematic structural diagram of a circuit of a display panel in a counter charging mode provided in an embodiment of the disclosure.

FIG. 6 is a flow chart of a display panel driving method provided in an embodiment of the disclosure.

FIG. 7 is a flow chart of S100 of a display panel driving method provided in an embodiment of the disclosure.

FIG. 8 is a schematic structural diagram of a circuit of a gate driving module including a gate driving unit provided in an embodiment of the disclosure.

FIG. 9 is a schematic diagram of voltages of scan signals in multiple scan lines provided in an embodiment of the disclosure.

FIG. 10 is a flow chart of S110 of a display panel driving method provided in an embodiment of the disclosure.

FIG. 11 is a structural view of a display apparatus provided in an embodiment of the disclosure.

FIG. 12 is a schematic structural diagram of a circuit of a display panel including a sensor provided in an embodiment of the disclosure.

### DESCRIPTION OF REFERENCE SIGNS

display panel—100, data line—10, source driving module—20, scan line—30, gate driving module—40, gate driving unit—41, first driving unit—411, second driving unit—412, voltage division unit—42, detection module—50, voltage-division control line—60, controller—70, pixel unit—80, sensor—90, display apparatus—1000, housing—200.

### DETAILED DESCRIPTION

The following will clearly and completely illustrate technical solutions of embodiments of the disclosure with reference to the accompanying drawings of embodiments of the disclosure. Apparently, embodiments described herein are merely some embodiments, rather than all embodiments, of the disclosure. Based on the embodiments of the disclosure, all other embodiments obtained by those of ordinary skill in the art without creative effort shall fall within the protection scope of the disclosure.

It may be noted that, the terms “first”, “second”, and the like used in the specification, the claims, and the accompany drawings are to distinguish different objects rather than describe a particular order. In addition, the terms “include”, “comprise”, and variations thereof are intended to cover non-exclusive inclusion.

In the specification, for convenience, wordings indicating directional or positional relationships, such as “middle”, “upper”, “lower”, “front”, “back”, “vertical”, “horizontal”, “top”, “bottom”, “inside”, and “outside”, are used for illustrating positional relationships between constituent elements with reference to the drawings, and are merely for facilitating the description of the specification and simplifying the description, rather than indicating or implying that a referred apparatus or element must have a particular orientation and be constructed and operated in the particular orientation. Therefore, they cannot be understood as limitations on the present disclosure. The positional relationships between the constituent elements may be changed as appropriate according to directions for describing the constituent elements. Therefore, appropriate replacements may be made according to situations without being limited to the wordings described in the specification.

In the description, unless otherwise specified and defined explicitly, terms “mount”, “mutually connect”, and “connect” should be understood in a broad sense. For example, a connection may be a fixed connection, or a detachable connection, or an integrated connection. It may be a mechanical connection or an electrical connection. It may be a direct mutual connection, or an indirect connection through middleware, or internal communication between two components. Those of ordinary skills in the art may understand meanings of the above-mentioned terms in the present disclosure according to situations.

In a display panel of the related art, when data lines transmit data signals to pixel units for charging, capacitances are formed between the data lines and gate scan lines, and between the data lines and common electrodes. The capacitances, together with the inherent resistance of the data lines, leads to relatively large voltage drops at one end of each of the data lines away from a source driving module, which results in uneven charging of the pixel units at two ends of each of the data lines, causing uneven display luminance in the display panel.

A gate driving module of a liquid crystal display (LCD) employs an efficient and precise scanning method, i.e., row-by-row scanning, ensuring each operation specifically targets one row of pixel units. The gate driving module is closely connected to gate terminals (Gate) of thin-film transistors (TFTs) in the pixel units, and is configured to control on-off of the TFTs in each row of pixel units. During the scanning process, the gate driving module activates the TFTs in pixels in an entire row at a time, so as to ensure synchronized response of the pixels in this row.

After the TFTs are turned on, the source driving module transmits row by row control voltages controlling luminance, grayscale, and color, through stable channels formed between source terminals (Source) and drain terminals (Drain) of the TFTs, to each pixel unit in the display panel precisely. However, during this process, capacitances are formed between the data lines and the gate scan lines, and between the data lines and the common electrodes. The capacitances, together with the inherent resistance of the data lines, leads to relatively large voltage drops at one end of each of the data lines away from the source driving module, which results in fully charging of the pixel units close to the source driving module and increasingly weak charging effect on the pixel units away from the source driving module, causing uneven charging of the pixel units on two ends of each of the data lines.

In the related display technologies, the above problems exist across various display panels such as LCD display panels and organic light-emitting diode (OLED) display panels. The charging disparity caused by uneven loading of the data lines directly impacts the luminance uniformity of the display panels, which potentially causes observable brightness inconsistencies during the viewing of users, thereby degrading overall visual experience. Therefore, how to solve this problem to ensure the luminance uniformity of the display panels has become a critical technical problem in the current display technologies.

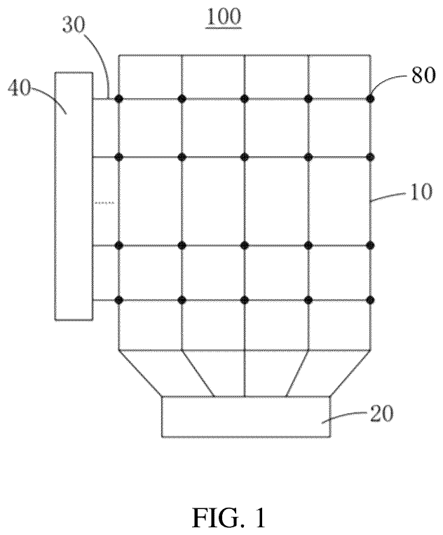

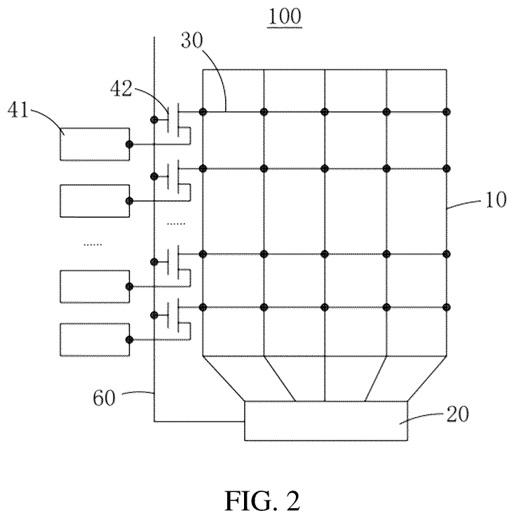

Reference is made to FIG. 1 and FIG. 2, where FIG. 1 is a schematic structural diagram of a circuit of a display panel provided in an embodiment of the disclosure, and FIG. 2 is a schematic structural diagram of a circuit of a gate driving module including a gate driving unit provided in an embodiment of the disclosure. The purpose of the disclosure is to provide a display panel 100, so as to address technical problems in display panels of the related art such as uneven display luminance caused by voltage drops in data lines.

The display panel 100 includes multiple pixel units 80, multiple data lines 10, a source driving module 20, multiple scan lines 30, and a gate driving module 40.

The multiple pixel units 80 are distributed in an array. Specifically, the multiple pixel units 80 are arranged according to strict layout rules within the array, ensuring uniformity and precision of the display effect of the display panel 100.

Each of the multiple data lines 10 is electrically connected to a column of the multiple pixel units 80. The source driving module 20 is electrically connected to the multiple data lines 10, and the source driving module 20 is configured to output data signals to the multiple data lines 10. As the central hub for the data signals, the source driving module 20 is connected to all data lines 10. The function of the source driving module 20 is to precisely allocate the data signals to each data line 10 connected thereto. It may be noted that, in this embodiment, the source driving module 20 is integrated within a driver integrated circuit (driver IC). In other embodiments, the source driving module 20 may be designed separately from the driver IC, which should not be construed as a limitation to the disclosure.

It may be noted that, since capacitances are formed between the data lines 10 and the scan lines 30, and between the data lines 10 and the common electrodes, together with the inherent resistance of the data lines 10, voltage drops exist in the data signals in the data lines 10. When the source driving module 20 outputs the data signals to the data lines 10, the voltages of the data signals close to the source driving module 20 remain higher, and the voltages of the data signals decrease as the distance from the data signals to the source driving module 20 increases. Consequently, for the same data line 10, the voltage of the data signal at a position away from the source driving module 20 is lower than the voltage of the data signal at a position close to the source driving module 20. In other words, the voltages of the data signals in the data lines 10 are sequentially decreased in the direction away from the source driving module 20.

Each of the multiple scan lines 30 is electrically connected to a row of the multiple pixel units 80 for inputting scan signals to the multiple pixel units 80. The gate driving module 40 is electrically connected to the multiple scan lines 30, and the gate driving module 40 is configured to output the scan signals to the multiple scan lines 30. In a direction away from the source driving module 20, voltages of the scan signals in the multiple scan lines 30 are sequentially increased.

When driving transistors in the pixel units 80 are turned on, the increase in the voltages of the scan signals will cause an increase in the on-state current of the driving transistors, thereby enhancing the charging rate of the pixel units 80. In other words, the data signals may be better written into the pixel units 80 within the same time period. In the direction away from the source driving module 20, the voltages of the scan signals in the multiple scan lines 30 are sequentially increased. In other words, in the direction away from the source driving module 20, the turned-on degrees of the driving transistors in the pixel units 80 are sequentially increased, which means that the charging rates of the pixel units 80 are sequentially increased.

The voltages of the scan signals increase as the distance from the scan signals to the source driving module 20 increases, which may compensate for potential insufficient charging of the pixel units 80 caused by the decrease in the voltages of the data signals, where the voltages of the data signals decrease as the distance from the data signals to the source driving module 20 increases. In this way, the charging effect of the pixel units 80 away from the source driving module 20 is similar to the charging effect of the pixel units 80 close to the source driving module 20, and thus the luminance of the pixel units 80 away from the source driving module 20 is similar to the luminance of the pixel units 80 close to the source driving module 20, so that the display luminance uniformity of the display panel 100 is improved. Moreover, it may be noted that, in this embodiment, in the direction away from the source driving module 20, the voltages of the scan signals in the multiple scan lines 30 are sequentially increased, enabling gate driving voltages on each row of pixel units 80 to increase sequentially, thereby enabling the turned-on degree and the charging rate of driving transistors in each row of pixel units 80 to increase sequentially. In this way, the charging effect and the luminance of each row of pixel units 80 remain similar or identical, thereby improving the overall luminance uniformity of the display panel.

Further, the gate driving module 40 includes multiple gate driving units 41 and multiple voltage division units 42. The quantity of the gate driving units 41, the quantity of the voltage division units 42, and the quantity of the scan lines 30 are mutually corresponding. In other words, one of the multiple gate driving units 41 is electrically connected to one of the multiple voltage division units 42 and one of the multiple scan lines 30. The multiple gate driving units 41 are configured to output driving signals to the multiple voltage division units 42, and the driving signals are converted into the scan signals through the multiple voltage division units 42.

In the display panel 100 provided in the disclosure, the multiple pixel units 80 are distributed in an array; the source driving module 20 is electrically connected to the multiple data lines 10, and the source driving module 20 is configured to output data signals to the multiple data lines 10; the gate driving module 40 is electrically connected to the multiple scan lines 30, and the gate driving module 40 is configured to output the scan signals to the multiple scan lines 30. In the direction away from the source driving module 20, the voltages of the scan signals in the multiple scan lines 30 are sequentially increased. In the direction away from the source driving module 20, the voltages of the scan signals in the multiple scan lines 30 are sequentially increased, enabling the turned-on degree and the charging rate of driving transistors in each row of pixel units 80 to increase sequentially. This may compensate for potential insufficient charging of the pixel units 80 caused by the decrease in voltages of the data signals, where the voltages of the data signals decrease as the distance from the data signals to the source driving module 20 increases. In this way, the charging effect and the luminance of each row of pixel units 80 remain similar or identical, thereby improving the overall luminance uniformity of the display panel 100.

Additionally, each voltage division unit 42 is electrically connected to one scan line 30, where each voltage division unit 42 is configured to perform voltage division to adjust the voltage of the scan signal in each scan line 30.

In this embodiment, the driving signals output by the multiple gate driving units 41 are identical, and in the direction away from the source driving module 20, voltages on the multiple voltage division units 42 are sequentially decreased, enabling the voltages of the scan signals in the scan lines 30 to sequentially increase.

It may be noted that, in this embodiment, the gate driving module 40 includes multiple gate driving units 41 and multiple voltage division units 42. In other embodiments, the gate driving module 40 may only include multiple gate driving units 41, and the driving signals output by the multiple gate driving unit 41 is the scan signals. In other words, the multiple gate driving units 41 directly output the scan signals to the multiple scan lines 30. This also belongs to the embodiments of the disclosure, and should not be construed as a limitation to the disclosure.

Reference is made to FIG. 1 and FIG. 2, in an embodiment, the multiple voltage division units 42 each includes a voltage division transistor T, and the display panel 100 further includes a voltage-division control line 60. A control terminal of the voltage division transistor T is electrically connected to the voltage-division control line 60, a first terminal of the voltage division transistor T is electrically connected to the one of the multiple gate driving units 41, and a second terminal of the voltage division transistor T is electrically connected to the one of the multiple scan lines 30. Optionally, in this embodiment, the first terminal of the voltage division transistor T is the source terminal, and the second terminal of the voltage division transistor T is the drain terminal. In other embodiments, the first terminal of the voltage division transistor T may be the drain terminal, and the second terminal of the voltage division transistor T may be the source terminal, which is not limited in the disclosure. Further optionally, in this embodiment, the voltage division transistor T includes but is not limited to a NMOS transistor or a PMOS transistor. In the case where the display panel 100 is a LCD display panel, the voltage division transistor T is the NMOS transistor. In the case where the display panel 100 is a OLED display panel, the voltage division transistor T is the PMOS transistor, which is not limited in the disclosure.

The voltage-division control line 60 is configured to output multiple voltage division signals to multiple voltage division transistors T, to make voltages on the multiple voltage division transistors T sequentially decrease in the direction away from the source driving module 20.

The voltage-division control line 60 is configured to output the multiple voltage division signals to the multiple voltage division transistors T. It may be noted that, the principle here is identical to that described above. That is, different driving signals at the gates of the multiple voltage division transistors T results in different turned-on degrees of the multiple voltage division transistors T, thereby controlling the scan signals output to the multiple scan lines 30 to be different. Specifically, the voltage-division control line 60 is configured to output multiple voltage division signals to the multiple voltage division transistors T. Therefore, in the direction away from the source driving module 20, the voltages of voltage division signals received by the multiple voltage division transistors T are sequentially increased, which causes the turned-on degrees of the multiple voltage division transistors T to sequentially increase, and causes the voltages of the driving signals on the multiple voltage division transistor T to sequentially decrease, thereby enabling the voltages of the scan signals in the multiple scan lines 30 to sequentially increase.

It may be noted that, the output frequency of the voltage division signal within one frame is the same as the number of rows of the pixel units 80. In other words, each time the gate driving unit 41 in one row outputs the driving signal, the voltage division signal needs to be correspondingly output.

It may be noted that, in this embodiment, the voltage division unit 42 functions as an equivalent resistor based on the transistor conduction characteristics. In other embodiments, the voltage division unit 42 may directly include a resistor, which is not limited in the disclosure.

It may be noted that, the determination of the voltage division signals is related to parameters including material properties of the voltage division transistors T and display specifications of the display panel 100, which should not be construed as a limitation to the disclosure.

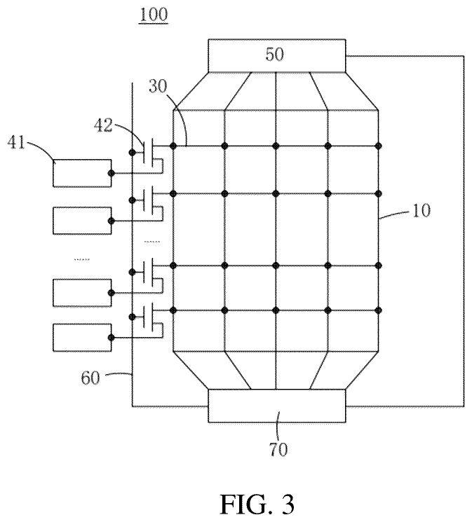

Reference is made to FIG. 3, which is a schematic structural diagram of a circuit of a display panel including a detection module provided in an embodiment of the disclosure. In an embodiment, the display panel 100 further includes a detection module 50 and a controller 70.

The detection module 50 is disposed on one end of the display panel 100 away from the source driving module 20, the detection module 50 is electrically connected to the multiple data lines 10, and the detection module 50 is configured to receive the data signals in the multiple data lines 10. In other words, one end of each of the data lines 10 is electrically connected to the source driving module 20, the other end of each of the data lines 10 is electrically connected to the detection module 50. The detection module 50 is configured to receive the data signals passing through the multiple pixel units 80 in each of the data lines 10. The data signal includes a first signal and a second signal, where the first signal is a data signal output from the source driving module 20, and the second signal is a data signal received by the detection module 50.

The first signal is converted into the second signal after passing through the multiple pixel units 80 in each of the data lines 10.

The controller 70 is electrically connected to the detection module 50. The controller 70 is configured to receive the second signal received by the detection module 50, determine value of voltage drop in each of the data lines 10 based on the difference between the first signal and the second signal, and generate a corresponding voltage division signal to the voltage-division control line 60 based on the value of voltage drop.

It may be noted that, in this embodiment, the controller 70 and the source driving module 20 are disposed on the same circuit board or the same chip, as illustrated in FIG. 2 and FIG. 3, which should not be construed as a limitation to the disclosure.

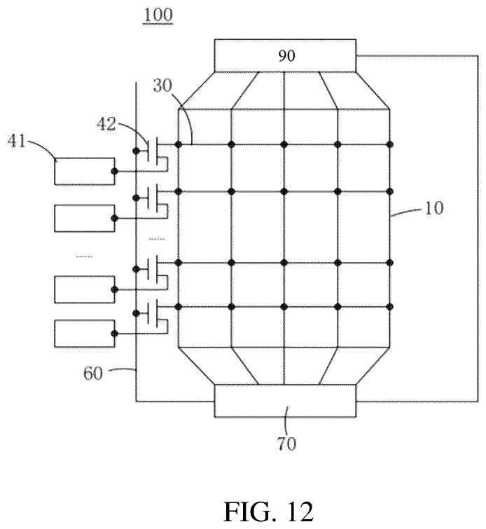

Reference is made to FIG. 12, which is a schematic structural diagram of a circuit of a display panel including a sensor provided in an embodiment of the disclosure. In an embodiment, the display panel 100 further includes a sensor 90 and the controller 70. The sensor 90 is disposed on one end of the display panel 100 away from the source driving module 20. The sensor 90 is configured to detect the luminance of the pixel units 80 and generate grayscale signals. The controller 70 is electrically connected to the sensor 90 and the voltage-division control line 60. The controller 70 is configured to receive the grayscale signals generated by the sensor 90, and generate the voltage division signals based on the grayscale signals and output the voltage division signals to the voltage-division control line 60.

Specifically, the controller 70 may be configured to receive the grayscale signals generated by the sensor 90, and calculate the voltage drop in the data line 10 based on the grayscale signals and a preset grayscale. Then, the controller 70 generate a corresponding voltage division signal based the value of the voltage drop, and output the voltage division signal to the voltage-division control line 60. It may be noted that, the preset grayscale is the display luminance of the pixel units 80 in normal display, usually the display luminance of the row of pixel units 80 closest to the source driving module 20. Therefore, the sensor 90 may also be disposed on the pixel units 80 closest to the source driving module 20, so as to detect the luminance of the pixel units 80 and generate a preset grayscale signal.

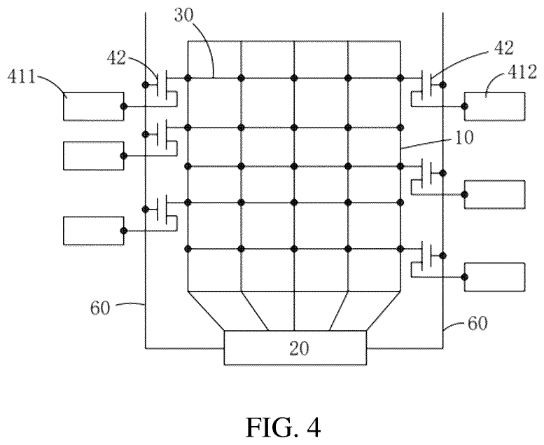

Reference is made to FIG. 4, which is a schematic circuit diagram of a display panel in a misalignment charging mode according to an embodiment of this application. In one embodiment, the display panel 100 operates in a misalignment charging display mode. The gate driving module 40 includes multiple first driving units 411 and multiple second driving units 412. The multiple first driving units 411 and the multiple second driving units 412 are respectively disposed at two ends of the display panel 100, and each of the multiple first driving units 411 and a corresponding second driving unit 412 are electrically connected to different scan lines 30.

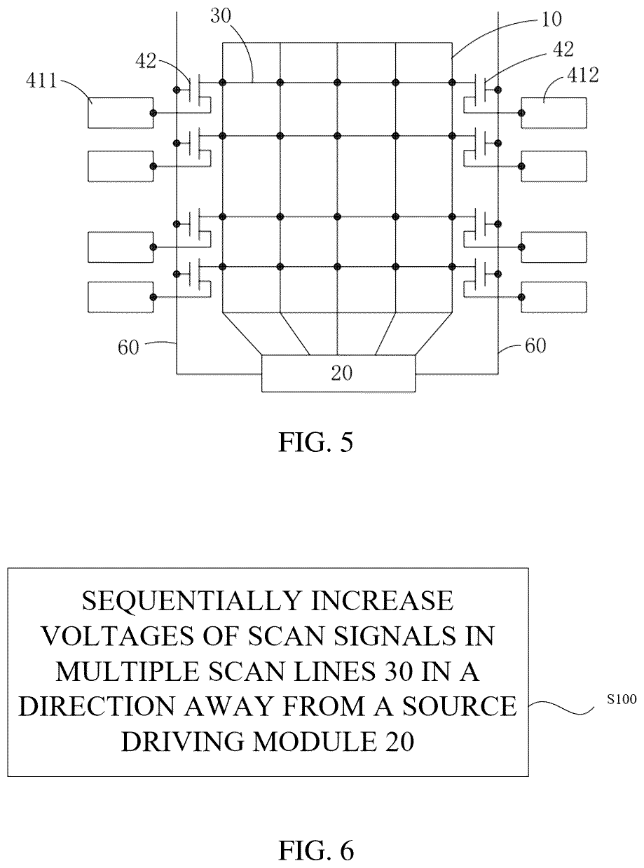

Reference is made to FIG. 5, which is a schematic circuit diagram of a display panel in a counter charging mode according to an embodiment of this application. In one embodiment, the display panel 100 operates in a counter charging display mode. The gate driving module 40 includes multiple first driving units 411 and multiple second driving units 412. The multiple first driving units 411 and the multiple second driving units 412 are respectively disposed at two ends of the display panel 100, and each of the multiple first driving units 411 and a corresponding second driving unit 412 are electrically connected to an identical scan line 30.

Reference is made to FIG. 6, which is a flow chart of a display panel driving method provided in an embodiment of the disclosure. The disclosure provides a display panel 100 driving method for driving the above display panel 100. The display panel 100 driving method includes operation at S100, and the detailed description of the operation at S100 is as follows.

At S100, voltages of scan signals in multiple scan lines are sequentially increased in a direction away from a source driving module.

In the display panel 100 driving method provided in the disclosure, in the direction away from the source driving module 20, the voltages of the scan signals in the multiple scan lines 30 are sequentially increased, enabling the turned-on degree and the charging rate of driving transistors in each row of pixel units 80 to increase sequentially. This may compensate for potential insufficient charging of the pixel units 80 caused by the decrease in voltages of the data signals, where the voltages of the data signals decrease as the distance from the data signals to the source driving module 20 increases. In this way, the charging effect and the luminance of each row of pixel units 80 remain similar or identical, thereby improving the overall luminance uniformity of the display panel 100.

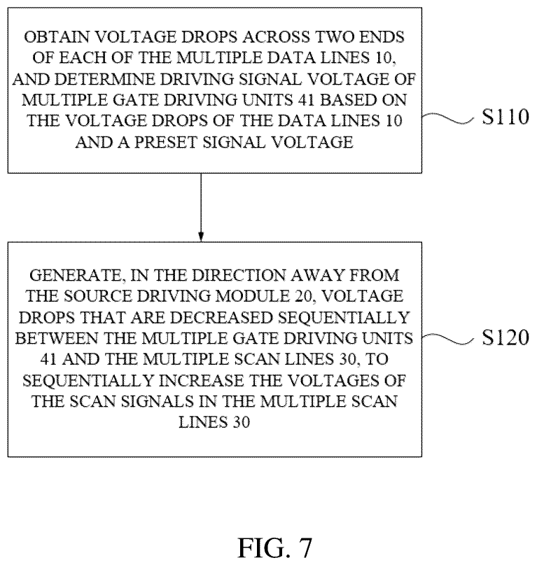

Reference is made to FIG. 7, which is a flow chart of S100 of a display panel driving method provided in an embodiment of the disclosure. In an embodiment, the operation at S100, i.e., the voltages of the scan signals are sequentially increased in the multiple scan lines in the direction away from the source driving module, includes operations at S110 and at S120. The detailed description of the operations at S110 and at S120 are as follows.

At S110, voltage drops across two ends of each of multiple data lines are obtained, and voltages of driving signals of multiple gate driving units are determined based on the voltage drops of the data lines and voltage of a preset signal.

For example, the voltage of the preset signal is defined as follows: under ideal conditions where no voltage drop exists in the data lines of the display panel, the voltage of the preset signal provided by the gate driving module is calculated based on the display luminance required by the display panel. In the disclosure, the voltage drop across two ends of each of the data lines 10 may be obtained. The voltage of the driving signal provided by the gate driving unit 41 at one end away from the source driving module 20 is calculated based on the voltage drop. For the pixel units 80 away from the source driving module 20, the luminance under the driving of this driving signal is consistent with the luminance under the voltage of the preset signal provided by the gate driving module in ideal conditions. Therefore, the voltages of the driving signals provided by the gate driving units 41 of the disclosure may be calculated through the following formula: voltage of driving signal=voltage of preset signal+Y, where Y represents the voltage required to be increased for the voltage drops of the data lines 10 of the display panel 100, which should not be construed as a limitation to the disclosure.

At S120, in the direction away from the source driving module 20, voltage drops that are decreased sequentially between the multiple gate driving units 41 and the multiple scan lines 30 are generated to sequentially increase the voltages of the scan signals in the multiple scan lines 30.

In the direction away from the source driving module 20, voltage drops that are decreased sequentially between the multiple gate driving units 41 and the multiple scan lines 30 are generated. In other words, one voltage division unit 42 is disposed between each of the multiple gate driving units 41 and each of the multiple scan lines 30, with the voltages on the multiple voltage division units 42 sequentially decreasing. Consequently, the voltages of the scan signals in the scan lines 30 sequentially increase.

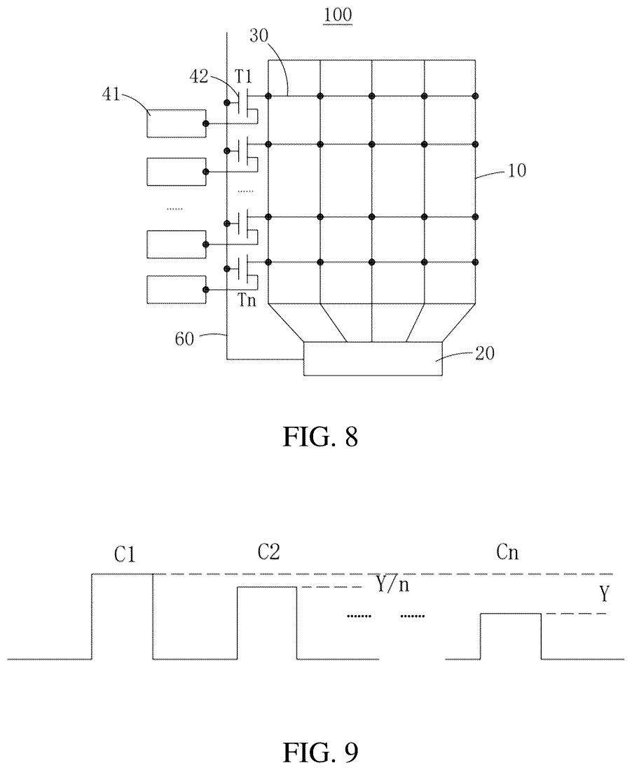

As illustrated in FIG. 8 and FIG. 9, where FIG. 8 is a schematic structural diagram of a circuit of a gate driving module including a gate driving unit provided in an embodiment of the disclosure, and FIG. 9 is a schematic diagram of voltages of scan signals in multiple scan lines provided in an embodiment of the disclosure, n gate driving units 41, n voltage division units 42, and n scan lines 30 in the figures are taken as an example in the disclosure. With the voltage division signals, voltages at the gates of the voltage division transistors T may be controlled to sequentially decrease from Tₙ to T₁, such that the turned-on degrees are sequentially decreased, and the resistances are sequentially decreased. Voltage division signal A is calculated through the following formula: Aₙ=A₁−(n−1) (α/n), where α is the gate voltage difference between T₁ and Tₙ, i.e., the voltage difference between the first voltage division signal and the last voltage division signal; Aₙ represents the voltage division signal A on the n-th voltage division unit, and A₁ to Aₙ correspond to T₁ to Tₙ in FIG. 8 respectively. Voltage difference B between the multiple scan lines 30 is calculated through the following formula: Bₙ=B₁−(n−1)(Y/n), where Y represents the voltage required to be increased for the voltage drops of the data lines 10 of the display panel 100, and Bₙ represents the voltage difference between the n-th scan line and the scan line closest to the source driving module 20. The voltages of the scan signals in the scan lines 30 are defined as C, which is calculated through the following formula: Cₙ=voltage of driving signal−Bₙ, where Cₙ represents the voltage of the scan signal in the n-th scan line, C₁ to Cₙ correspond to T₁ to Tₙ in FIG. 8 respectively, and as illustrated in FIG. 8, the sequential decrease of the voltages of C₁ to Cₙ represents that the voltages of the scan signals in the multiple scan lines are sequentially increased in the direction away from the source driving module 20.

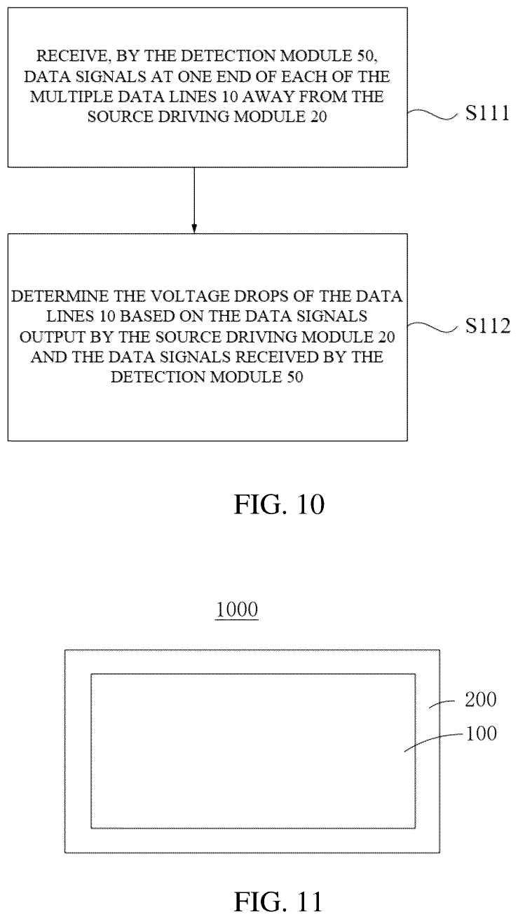

Reference is made to FIG. 10, which is a flow chart of S110 of a display panel driving method provided in an embodiment of the disclosure. In an embodiment, the operation at S110, i.e., the voltage drops across two ends of each of the multiple data lines are obtained, includes operations at S111 and S112. The detailed description of the operations at S111 and S112 are as follows.

At S111, data signals at one end of each of the multiple data lines 10 away from the source driving module 20 are received through the detection module 50.

At S112, the voltage drops of the data lines 10 are determined based on the data signals output by the source driving module 20 and the data signals received by the detection module 50.

The detection module 50 is configured to receive the data signals passing through the multiple pixel units 80 in each of the data lines 10. The data signal includes a first signal and a second signal, where the first signal is a data signal output from the source driving module 20, and the second signal is a data signal received by the detection module 50. The first signal is converted into the second signal after passing through the multiple pixel units 80 in each of the data lines 10.

The controller 70 is electrically connected to the detection module 50. The controller 70 is configured to receive the second signal received by the detection module 50, determine value of voltage drop in each of the data lines 10 based on the difference between the first signal and the second signal, and generate a corresponding voltage division signal to the voltage-division control line 60 based on the value of voltage drop.

In an embodiment, the operation at S110, i.e., the voltage drops across two ends of each of the multiple data lines are obtained, includes operations at S113 and S114. The detailed description of the operations at S113 and S114 are as follows

At S113, luminance of pixel units 80 is detected by a sensor 90, and grayscale signals are generated.

At S114, voltage drop of each of the multiple data lines 10 is determined based on the grayscale signals by a controller 70.

Specifically, the controller 70 may be configured to receive the grayscale signals generated by the sensor 90, and calculate the voltage drop in the data line 10 based on the grayscale signals and a preset grayscale. Then, the controller 70 generate a corresponding voltage division signal based the value of the voltage drop, and output the voltage division signal to the voltage-division control line 60. It may be noted that, the preset grayscale is the display luminance of the pixel units 80 in normal display, usually the row of pixel units 80 closest to the source driving module 20. Therefore, the sensor 90 may also be disposed on the pixel units 80 closest to the source driving module 20, so as to detect the luminance of the pixel units 80 and generate a preset grayscale signal.

Reference is made to FIG. 11, which is a structural view of a display apparatus provided in an embodiment of the disclosure. The disclosure further provides a display apparatus 1000. The display apparatus 1000 includes a housing 200 and the display panel 100, and the housing 200 is configured to accommodate the display panel 100, so as to protect the display panel 100.

The terms of “embodiment” and “implementation” mentioned in the present disclosure means that the specific features, structures, or characteristics described with reference to the embodiments may be encompassed in at least one embodiment of the present disclosure.

The phrase at various locations in the specification does not necessarily refer to the same embodiment, or an independent or alternative embodiment exclusive of another embodiment.

Those skilled in the art may understand explicitly and implicitly that the embodiments described in the present disclosure may be combined with other embodiments. In addition, it may also be understood that the features, structures or characteristics described in embodiments of the present disclosure may be combined as desired to obtain embodiments without departing from the spirit and scope of the technical solution of the present disclosure if there is no contradiction between the embodiments.

The above are some embodiments of the disclosure. It may be pointed out that for those of ordinary skill in the art, without departing from principles of the disclosure, several improvements and refinements can also be made. These improvements and refinements are also considered to fall within the scope of protection of the disclosure.

What is claimed is:

1. A display panel, comprising:
a plurality of pixel units distributed in an array;
a plurality of data lines, wherein each of the plurality of data lines is electrically connected to a column of the plurality of pixel units;
a source driving module, wherein the source driving module is electrically connected to the plurality of data lines, and the source driving module is configured to output data signals to the plurality of data lines;
a plurality of scan lines, wherein each of the plurality of scan lines is electrically connected to a row of the plurality of pixel units for inputting scan signals to the plurality of pixel units; and
a gate driving module, wherein the gate driving module is electrically connected to the plurality of scan lines, and the gate driving module is configured to output the scan signals to the plurality of scan lines; wherein in a direction away from the source driving module, voltages of the scan signals in the plurality of scan lines are sequentially increased; the gate driving module comprises a plurality of gate driving units and a plurality of voltage division units, wherein one of the plurality of gate driving units is electrically connected to one of the plurality of voltage division units and one of the plurality of scan lines, the plurality of gate driving units are configured to output driving signals to the plurality of voltage division units, and the driving signals are converted into the scan signals through the plurality of voltage division units.

2. The display panel of claim 1, wherein the driving signals output by the plurality of gate driving units are identical, and in the direction away from the source driving module, voltages on the plurality of voltage division units are sequentially decreased.

3. The display panel of claim 2, wherein the plurality of voltage division units each comprises a voltage division transistor, and the display panel further comprises a voltage-division control line; a control terminal of the voltage division transistor is electrically connected to the voltage-division control line, a first terminal of the voltage division transistor is electrically connected to the one of the plurality of gate driving units, and a second terminal of the voltage division transistor is electrically connected to the one of the plurality of scan lines, wherein the voltage-division control line is configured to output a plurality of voltage division signals to a plurality of voltage division transistors, to make voltages on the plurality of voltage division transistors sequentially decrease in the direction away from the source driving module.

4. The display panel of claim 3, wherein the display panel further comprises a detection module and a controller, the detection module is disposed on one end of the display panel away from the source driving module, the detection module is electrically connected to the plurality of data lines, and the detection module is configured to receive the data signals in the plurality of data lines; and the controller is electrically connected to the detection module, and the controller is configured to generate, based on the data signals received by the detection module, the plurality of voltage division signals to output the plurality of voltage division signals to the voltage-division control line.

5. The display panel of claim 3, wherein the display panel further comprises a sensor and a controller, the sensor is disposed on one end of the display panel away from the source driving module, and the sensor is configured to detect luminance of the pixel units and generate grayscale signals; and the controller is electrically connected to the sensor and the voltage-division control line, the controller is configured to receive the grayscale signals generated by the sensor, and generate the plurality of voltage division signals and output the plurality of voltage division signals to the voltage-division control line.

6. The display panel of claim 1, wherein the gate driving module comprises a plurality of first driving units and a plurality of second driving units, the plurality of first driving units and the plurality of second driving units are respectively disposed on two ends of the display panel, and each of the plurality of first driving units and a corresponding second driving unit are electrically connected to different scan lines.

7. The display panel of claim 1, wherein the gate driving module comprises a plurality of first driving units and a plurality of second driving units, the plurality of first driving units and the plurality of second driving units are respectively disposed on two ends of the display panel, and each of the plurality of first driving units and a corresponding second driving unit are electrically connected to an identical scan line.

8. A display panel driving method for driving the display panel of claim 1, comprising:
sequentially increasing voltages of scan signals in a plurality of scan lines in a direction away from a source driving module.

9. The display panel driving method of claim 8, wherein sequentially increasing the voltages of the scan signals in the plurality of scan lines in the direction away from the source driving module comprises:
obtaining voltage drops across two ends of each of a plurality of data lines, and determining voltages of driving signals of a plurality of gate driving units based on the voltage drops of the plurality of data lines and voltage of a preset signal; and
generating, in the direction away from the source driving module, voltage drops that are decreased sequentially between the plurality of gate driving units and the plurality of scan lines, to sequentially increase the voltages of the scan signals in the plurality of scan lines.

10. The display panel driving method of claim 9, wherein obtaining the voltage drops at two ends of each of the plurality of data lines comprises:
receiving, by the detection module, data signals at one end of each of the plurality of data lines away from the source driving module; and
determining the voltage drops of the data lines based on the data signals output by the source driving module and the data signals received by the detection module.

11. A display apparatus, comprising a housing and a display panel, wherein the housing is configured to accommodate the display panel, and the display panel comprises:
a plurality of pixel units distributed in an array;
a plurality of data lines, wherein each of the plurality of data lines is electrically connected to a column of the plurality of pixel units;
a source driving module, wherein the source driving module is electrically connected to the plurality of data lines, and the source driving module is configured to output data signals to the plurality of data lines;
a plurality of scan lines, wherein each of the plurality of scan lines is electrically connected to a row of the plurality of pixel units for inputting scan signals to the plurality of pixel units; and
a gate driving module, wherein the gate driving module is electrically connected to the plurality of scan lines, and the gate driving module is configured to output the scan signals to the plurality of scan lines; wherein in a direction away from the source driving module, voltages of the scan signals in the plurality of scan lines are sequentially increased; the gate driving module comprises a plurality of gate driving units and a plurality of voltage division units, wherein one of the plurality of gate driving units is electrically connected to one of the plurality of voltage division units and one of the plurality of scan lines, the plurality of gate driving units are configured to output driving signals to the plurality of voltage division units, and the driving signals are converted into the scan signals through the plurality of voltage division units.

12. The display apparatus of claim 11, wherein the driving signals output by the plurality of gate driving units are identical, and in the direction away from the source driving module, voltages on the plurality of voltage division units are sequentially decreased.

13. The display apparatus of claim 12, wherein the plurality of voltage division units each comprises a voltage division transistor, and the display panel further comprises a voltage-division control line; a control terminal of the voltage division transistor is electrically connected to the voltage-division control line, a first terminal of the voltage division transistor is electrically connected to the one of the plurality of gate driving units, and a second terminal of the voltage division transistor is electrically connected to the one of the plurality of scan lines, wherein the voltage-division control line is configured to output a plurality of voltage division signals to a plurality of voltage division transistors, to make voltages on the plurality of voltage division transistors sequentially decrease in the direction away from the source driving module.

14. The display apparatus of claim 13, wherein the display panel further comprises a detection module and a controller, the detection module is disposed on one end of the display panel away from the source driving module, the detection module is electrically connected to the plurality of data lines, and the detection module is configured to receive the data signals in the plurality of data lines; and the controller is electrically connected to the detection module, and the controller is configured to generate, based on the data signals received by the detection module, the plurality of voltage division signals to output the plurality of voltage division signals to the voltage-division control line.

15. The display apparatus of claim 13, wherein the display panel further comprises a sensor and a controller, the sensor is disposed on one end of the display panel away from the source driving module, and the sensor is configured to detect luminance of the pixel units and generate grayscale signals; and the controller is electrically connected to the sensor and the voltage-division control line, the controller is configured to receive the grayscale signals generated by the sensor, and generate the plurality of voltage division signals and output the plurality of voltage division signals to the voltage-division control line.

16. The display apparatus of claim 11, wherein the gate driving module comprises a plurality of first driving units and a plurality of second driving units, the plurality of first driving units and the plurality of second driving units are respectively disposed on two ends of the display panel, and each of the plurality of first driving units and a corresponding second driving unit are electrically connected to different scan lines.

17. The display apparatus of claim 11, wherein the gate driving module comprises a plurality of first driving units and a plurality of second driving units, the plurality of first driving units and the plurality of second driving units are respectively disposed on two ends of the display panel, and each of the plurality of first driving units and a corresponding second driving unit are electrically connected to an identical scan line.
